(19) United States
(12) Patent Application Publication
(10) Pub. No.: US 2005/0269347 A1
(43) Pub. Date: Dec. 8, 2005

(54) Tobacco product dispensing

(76) Inventors: John W. Templer, Amarillo, TX (US); Mark Allsup, Fort Worth, TX (US)

Correspondence Address: FISH & RICHARDSON P.C., P.O. BOX 1022, MINNEAPOLIS, MN, 55440-1022, US

(21) Appl. No.: 11/134,518

(22) Filed: May 23, 2005

Related U.S. Application Data
(60) Provisional application No. 60/574,933, filed on May 28, 2004.
(60) Provisional application No. 60/606,502, filed on Sep. 2, 2004.

(51) Int. Cl. B65H 1/00; G07F 11/00; G07F 11/16; B65H 1/08; B65G 59/00

(52) U.S. Cl. 221/232

(57) ABSTRACT

A device for storing and dispensing tobacco products includes a housing configured to store tobacco product packages and an electronic system coupled to the housing. The electronic system is configured to enable dispensing of the packages from the housing and to track information related to the dispensing of the packages from the housing. The housing may contain a plurality of chambers, each configured to store a different brand of tobacco product packages. The information may relate to inventory of the packages and/or to operator use of the device. A method of storing and dispensing tobacco products includes storing packages of tobacco products in a housing; electronically dispensing one or more of the packages from the housing; and electronically tracking information related to the dispensing of the packages from the housing.

### CLAIM OF PRIORITY

This application claims priority under 35 U.S.C. §119(e) to U.S. Patent Application Ser. No. 60/574,933, filed on May 28, 2004, and to U.S. patent application Ser. No. 60/606,502, filed on Sep. 2, 2004, each of which is incorporated by reference.

### TECHNICAL FIELD

This application relates to an electronic device for use by tobacco retailers in controlling and monitoring the dispensing of cigarettes and other tobacco products.

### BACKGROUND

Tobacco retailers, such as convenience stores, drug stores, and supermarkets, face many challenges with the sale of tobacco products. These challenges include thefts by employees and customers, restrictions of sales to minors, and improper sales of individual, unpackaged cigarettes. In addition, most tobacco retailers have no choice but to manually track tobacco sales and inventory. This manual tracking is prone to error and manipulation by employees. Manual tracking of inventory also puts demands on the time and resources of tobacco retailers when determining their restocking and reordering needs.

### SUMMARY

In one aspect, a device for storing and dispensing tobacco products includes a housing configured to store tobacco product packages and an electronic system coupled to the housing. The electronic system is configured to enable dispensing of the packages from the housing and to track information related to the dispensing of the packages from the housing.

Implementations of this aspect may include one or more of the following. For example, the housing may contain a plurality of chambers, each configured to store a different brand of tobacco product packages. The housing may include a slot for dispensing the packages and/or a lockable door configured to be opened to stock the product packages in the housing. The electronic system may include an input device that enables an operator to dispense the packages from the housing, a storage device that stores the information related to the dispensing of the packages from the housing, and/or an output device that enables an operator to obtain the information related to the dispensing of the packages from the housing. The information may relate to inventory of the packages and/or to operator use of the device. The housing may include a portion that enables at least some of the packages to be viewed from outside the housing and/or a portion configured to display advertising information related to the packages.

In another aspect, a method of storing and dispensing tobacco products includes: storing packages of tobacco products in a housing; electronically dispensing one or more of the packages from the housing; and electronically tracking information related to the dispensing of the packages from the housing.

Implementations of this aspect may include one or more of the following. For example, storing the packages in the housing may include storing different brands of the packages in different chambers in the housing. Electronically dispensing one or more of the packages may include actuating an input device. Electronically tracking information may include electronically storing the information in a storage device and/or receiving output of the information. The information may relate to inventory of the packages and/or to operator use of the device. At least some of the packages may be viewed from outside the housing and/or advertising information related to the packages may be displayed on the housing.

The details of one or more implementations are set forth in the accompanying drawings and the description below. Other features will be apparent from the description, the drawings, and the claims.

### BRIEF DESCRIPTION OF DRAWINGS

FIG. 1 is a diagram of a cabinet for dispensing tobacco products.

FIG. 2 is a diagram of the cabinet of FIG. 1 with the door open.

FIG. 3 is a diagram of another implementation of a cabinet for dispensing tobacco products.

FIG. 4 is a diagram of yet another implementation of a cabinet for dispensing tobacco products.

### DETAILED DESCRIPTION

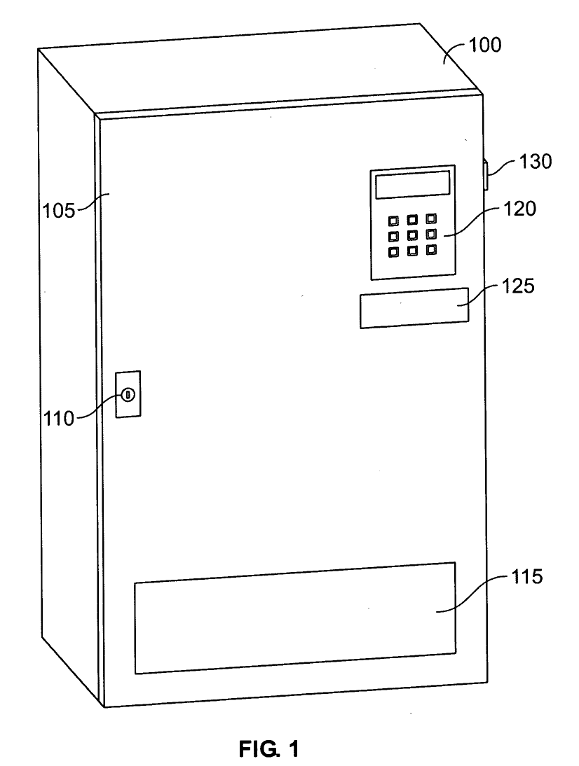

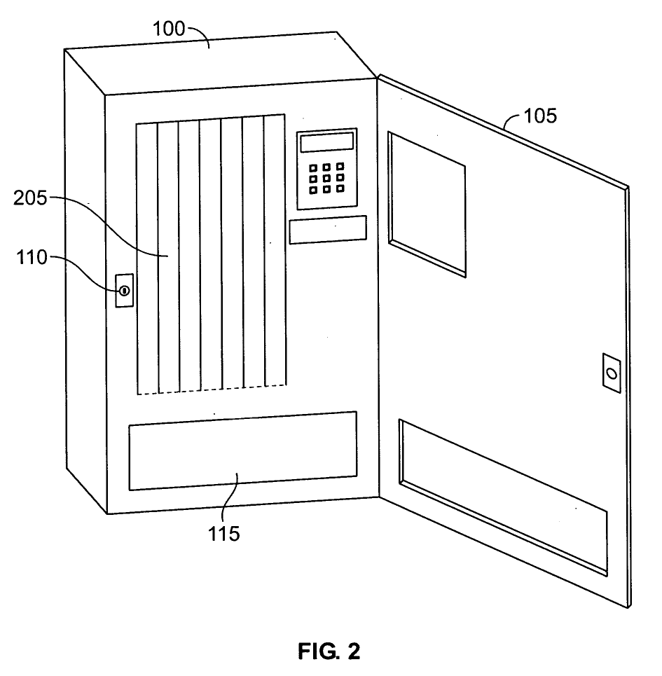

With reference to FIGS. 1 and 2, an electronically controlled and monitored dispensing cabinet 100 includes numerous individual chambers 205 designed to store cigarette packages. The cabinet 100 includes a door 105 that may be secured using a locking mechanism 110 such that the chambers 205 are accessible only to designated personnel, such as store managers or owners. These designated personnel can stock the cabinet by adding cigarette packages to the individual chambers. Each of the chambers is electronically assigned to the particular brand of cigarette it contains through use of an operator keypad 120 or a computer port 130. Such assignments are configurable by the designated personnel, and reference the specific SKU for the particular brand of cigarette.

Once the cabinet is stocked and locked, an operator, such as a store clerk, can dispense individual cigarette packages or cartons. All the operator must do is select which brand of cigarette the customer requests, and provide his or her personal operator code using the keypad 120. Once selected, the desired cigarette package is released from the corresponding chamber, which allows the operator to take a pack from the dispensing slot 115 and complete the transaction with the customer. Each cigarette package released from the cabinet is electronically recorded, thereby providing a record to accompany the corresponding transaction. This allows the inventory to be physically locked, yet available for operators to sell individual packages or cartons to customers.

The cabinet includes an electronic system capable of tracking and storing information relating to the inventory of the chambers and the disbursement of the cigarette packages. This information can be accessed through the computer port 130 or by using an integrated printer 125.

This electronic capability facilitates inventory control in a variety of ways. First, each time an operator dispenses a cigarette pack or carton, the system records information pertaining to that individual transaction. This information includes, but is not limited to, the time the transaction occurred, the individual product SKU of the cigarette (thus recording the brand of cigarette sold), and the operator who dispensed the cigarette package. The information for each transaction is stored in the system, which allows the designated personnel to review individual transactions. Second, in addition to the individual sales records, the system provides real-time inventory and aggregate sales totals. These aggregate records provide the tobacco retailer with accurate and easily accessible data in order to assess restocking and reordering or tobacco products.

Once the cabinet is stocked and locked, an operator, such as a store clerk, can dispense individual cigarette packages or cartons. All the operator must do is select which brand of cigarette the customer requests, and provide his or her personal operator code using the keypad 120. Once selected, the desired cigarette package is released from the corresponding chamber, which allows the operator to take a pack from the dispensing slot 115 and complete the transaction with the customer. Each cigarette package released from the cabinet is electronically recorded, thereby providing a record to accompany the corresponding transaction. This allows the inventory to be physically locked, yet available for operators to sell individual packages or cartons to customers.

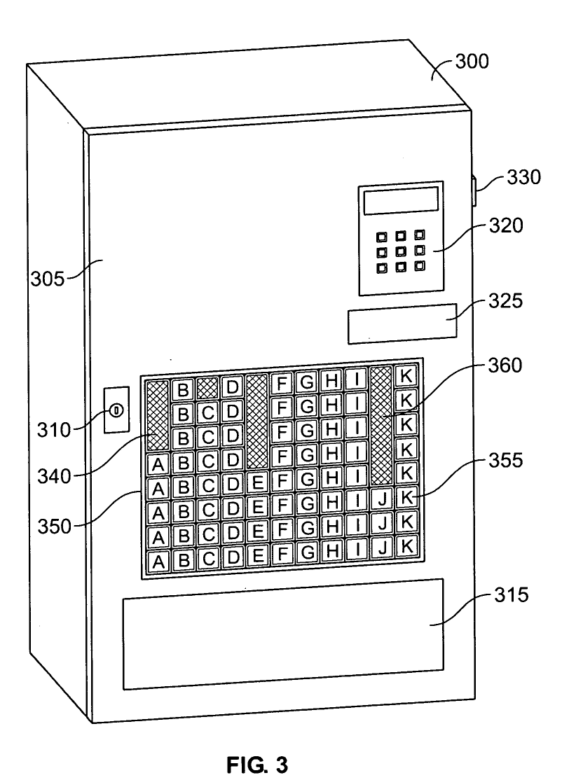

Referring to FIG. 3, in another implementation, an electronically controlled and monitored dispensing cabinet 300 for dispensing cigarette packages 355. Cabinet 300 has a door 305, a lock 310, a slot 315, a keypad 320, a printer 325, and a computer port 330 that function analogous to door 105, lock 110, slot 115, keypad 120, printer 125, and computer port 130, respectively, described above. Door 305 has a transparent or translucent window 350 made from glass, plexiglass, plastic, or another similar material. Window 350 allows numerous individual chambers 340 behind door 305 to be visible from outside of cabinet 300. Window 350 assists with marketing of cigarettes by allowing a customer to view the cigarette packages 355 stored in chambers 340. For example, as shown in FIG. 3, chambers 340 contain cigarette packages 355 of Brands A through K. In addition, window 350 allows the owner or operator to view the amount of each brand of cigarette that is remaining in the cabinet. When a space 360 appears above packages 355, the owner or operator knows that it is time to restock that particular brand of cigarette. Thus, window 350 provides a visual inventory to supplement the electronic inventory that can be accessed through keypad 320, printer 325, and/or computer port 330.

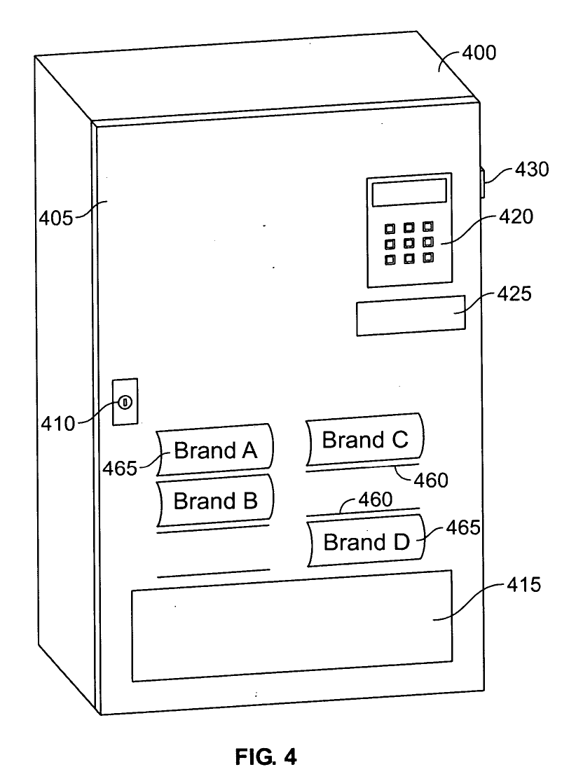

Referring to FIG. 4, in another implementation, an electronically controlled and monitored dispensing cabinet 400 for dispensing cigarette packages. Cabinet 400 has a door 405, a lock 410, a slot 415, a keypad 420, a printer 425, and a computer port 430 that function analogous to door 105, lock 110, slot 115, keypad 120, printer 125, and computer port 130, respectively, described above. Door 405 has one or more grooves 460 that receive placards 465 for advertising the brands of cigarettes being housed in cabinet 400. Grooves 460 and placards 465 help the owner or operator market the cigarette packages being sold via dispensing cabinet 400.

A number of implementations have been described. Nevertheless, it will be understood that various modifications may be made. For example, the door can include one ore more electronic or video displays that includes advertising information for the cigarettes being sold. This and other implementations are within the scope of the following claims.

1. A device for storing and dispensing tobacco products, the device comprising:
a housing configured to store tobacco product packages; and
an electronic system coupled to the housing, the electronic system configured to enable dispensing of the packages from the housing and to track information related to the dispensing of the packages from the housing.

2. The device of claim 1 wherein the housing contains a plurality of chambers, each chamber configured to store a different brand of tobacco product packages.

3. The device of claim 1 wherein the housing comprises a slot for dispensing the packages.

4. The device of claim 1 wherein the housing comprises a lockable door configured to be opened to stock the product packages in the housing.

5. The device of claim 1 wherein the electronic system comprises an input device that enables an operator to dispense the packages from the housing.

6. The device of claim 1 wherein the electronic system comprises a storage device that stores the information related to the dispensing of the packages from the housing.

7. The device of claim 1 wherein the electronic system comprises an output device that enables an operator to obtain the information related to the dispensing of the packages from the housing.

8. The device of claim 1 wherein the information relates to inventory of the packages.

9. The device of claim 1 wherein the information relates to operator use of the device.

10. The device of claim 1 wherein the housing further includes a portion that enables at least some of the packages to be viewed from outside the housing.

11. The device of claim 1 wherein the housing further includes a portion configured to display advertising information related to the packages.

12. A method of storing and dispensing tobacco products comprising:
storing packages of tobacco products in a housing;
electronically dispensing one or more of the packages from the housing; and
electronically tracking information related to the dispensing of the packages from the housing.

13. The method of claim 1 wherein storing the packages in the housing comprises storing different brands of the packages in different chambers in the housing.

14. The method of claim 1 wherein electronically dispensing one or more of the packages comprises actuating an input device.

15. The method of claim 1 wherein electronically tracking information comprises electronically storing the information in a storage device.

16. The method of claim 1 wherein electronically tracking information comprises receiving output of the information.

17. The method of claim 1 wherein the information relates to inventory of the packages.

18. The method of claim 1 wherein the information relates to operator use of the device.

19. The method of claim 1 further comprising permitting at least some of the packages to be viewed from outside the housing.

20. The method of claim 1 further comprising displaying advertising information related to the packages.
